(19) United States
(12) Patent Application Publication
(10) Pub. No.: US 2003/0020933 A1
(43) Pub. Date: Jan. 30, 2003

(54) Method and apparatus for reducing inaccuracies when processing color data with a matrix

(76) Inventor: Kevin J. Youngers, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/911,954

(22) Filed: Jul. 24, 2001

(51) Int. Cl. H04N 1/60; H04N 1/50

(52) U.S. Cl. 358/1.9; 358/3.24; 358/518

(57) ABSTRACT

A method and apparatus that reduces the inaccuracies in the matrix operation in the dark areas of an image.

### RELATED APPLICATIONS

This application is related to the application “Method and apparatus for reducing inaccuracies when processing color data with a tone map” that has the H.P. docket number 10016754 and was filed on the same day as this application.

### FIELD OF THE INVENTION

The present invention relates generally to digital images and more specifically to a method and device for reducing inaccuracies when processing or creating color data.

### BACKGROUND OF THE INVENTION

Digital cameras and scanners create image information by converting light into electrical signals using a photo-sensor. Typically the photo-sensors are charged coupled devices (CCD). The CCD's typically have 3 color filters arranged over the surface to sample the light in three different colors. Typically these are red, green, and blue. Scanners typically use an internal light source to illuminate the page. Cameras may use only the ambient illumination or they may add illumination to the scene using a flash. The electrical signal created by each pixel in the CCD is a function of the illumination in the scene, the reflectance of the object in the scene, the pass band of the filter over the pixel, and the inherent sensitivity of the CCD to light. One of the goals of these systems is to reproduce the color of an object as perceived by the human eye. The human eye has a three-color detector system that senses red, green, and blue. Unfortunately it is difficult to match the three colors that the eye detects with the available sets of filters, CCD's, and illuminants. One method used to help match the machine detected colors with the human perceived colors is call matrix modification. The 3 colors from the CCD are used to create 3 new output colors that more closely match the human perception. For example the resulting matrix modified red color may be generated by taking 85% of the red CCD output plus 25% of the green CCD output plus 7% of the blue CCD output (see FIG. 1). The ratios used for each matrix-modified color are typically dependent on the specific CCD, filter set and system performance for each type of camera or scanner. The matrix operation can be done in the scanner or camera hardware, or the raw color data may be sent to a computer where the image processing (including the matrix operation) is done.

Some scanners and cameras may detect more than three different colors of light. For example some scanners may detect as many as 6 different colors. These additional colors can help the accuracy of the scanner or may be used to increase the number of colors detected. The output colors of these scanners may be a function of all 6 colors detected by the scanner.

CCD's sample light and convert it into electrical signals. These electrical signals are then converted into digital information typically using an A-to-D converter. CCD's are typically fairly linear in response to the intensity of light falling on each pixel. The human eye is not linear in response to intensity. The human eye responds more to density, which is the log of intensity. Because of this phenomenon a given change in intensity will be much more noticeable to the human eye if the change occurs in a dark area as compared to a light area of an image. For example in a system with 8 bits of resolution or 256 levels of intensity and 0 as black and 255 as white, a 2-count change in intensity from 10 to 12 may be much more noticeable to the human eye than the same 2-count change in intensity from 200 to 202.

The number of levels of light that the CCD and A-to-D converters can create has increased in recent years. Older scanners and cameras typically had 8 bits per color (256 levels) for a total of 24 bits. Today CCDs and A-to-D converters create 10, 12 and even 16 bits per color. In addition to the increase in the number of levels, currently available CCDs have improved their signal-to-noise ratios. This means that more of the total number of levels are actual signal instead of noise. These changes have made reproductions of the dark areas of the images much more accurate.

Unfortunately these changes have also created some problems. One of these problems is the matrix operation. In the dark areas of the image, inaccuracies in the matrix operation may show up as slight unintentional color changes in the image. The human eye may be unable to detect a slight change in brightness, but the human eye is very sensitive to small color shifts in the dark areas of an image. These small changes in color in the dark area of images can reduce the usability of these images.

What is needed is a method and apparatus that reduces the inaccuracies in the matrix operation in the dark areas of the image.

### SUMMARY OF THE INVENTION

A method and device for improving the matrix operation in dark areas of an image.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a diagram of a matrix operation for one output color.

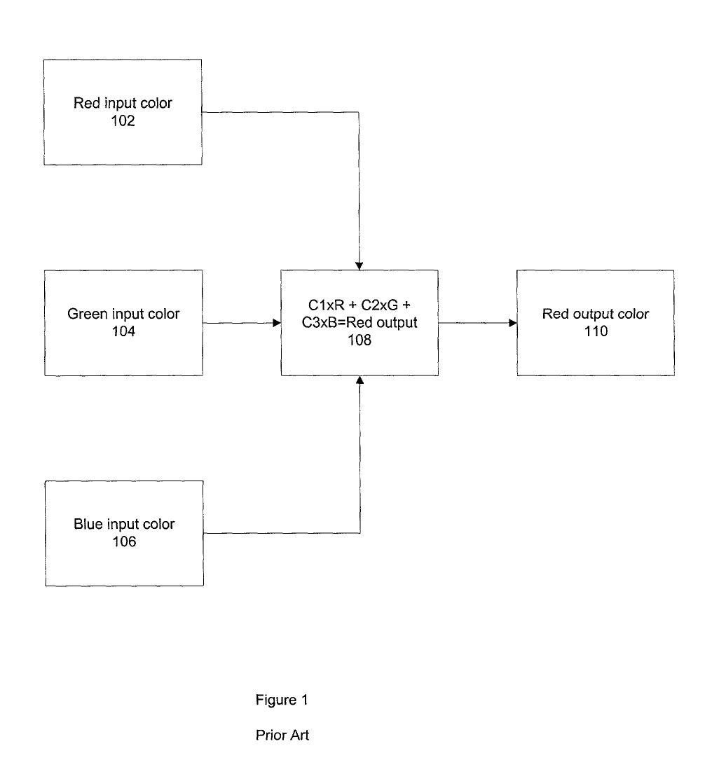

FIG. 2 is a flow chart for the matrix operation in accordance with one embodiment of the current invention.

FIG. 3 is a flow chart for the matrix operation in accordance with another embodiment of the current invention.

FIG. 4 is a flow chart for the matrix operation in accordance with another embodiment of the current invention.

### DETAILED DESCRIPTION OF THE PREFERRED EMBODIMENT

A method and apparatus that reduces the inaccuracies in the matrix operation in the dark areas of the image can increase the number of usable images.

The raw color components of a sample or pixel from the photo-sensor of scanners, cameras, or the like are typically mixed together using a matrix operation to produce a more accurate output color. The matrix operation creates new output color components for each pixel by mixing the raw color components from the pixel. For example the output red component is composed from a ratio of the raw red, raw green, and raw blue color components. The output green component is composed from a different ratio of the raw red, raw green and raw blue color components. And the output blue color component would be composed of a third ratio of the three raw color components. Typically each new color component is composed mostly from the matching raw color component, i.e. the signal level of the output red color component is mainly determined by the raw red signal level.

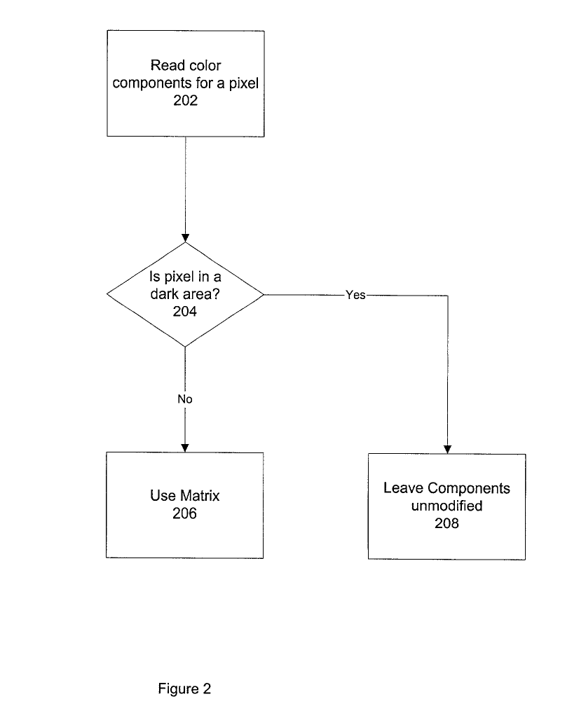

When the pixel or sample is from a dark area in the image, inaccuracies in the matrix operation may cause unacceptable color shifts for the pixel. The image can be improved by avoiding the color shifts in the dark areas of the image by selectively applying the matrix operation only to pixels that are not in a dark area of the image (see FIG. 2). The selective matrix operation can be performed in the hardware of the scanner, camera, color copier, or the like, or the raw color data can be transferred to a computer where the selective matrix operation can be performed.

There are numerous methods to determine if a pixel is in a dark area of an image. In one embodiment a threshold is defined and if any raw color component in a pixel is greater than the threshold the pixel is considered to be in a lighter area of the image. In a preferred embodiment the threshold level or value is approximately 10 eight-bit counts and in another preferred embodiment the threshold level or value is approximately 6 eight-bit counts.

In another embodiment there may be a threshold for each raw color contained in a pixel. For example in a pixel that contains 3 color components (red, green, and blue) there may be a red threshold, a green threshold, and a blue threshold. The pixel would be considered to be in a dark area only when the raw red color was below the red threshold and the raw green color was below the green threshold and the raw blue color was below the blue threshold. In another embodiment there may be three different raw color thresholds for each of the three output colors for a total of nine different thresholds.

In another embodiment the threshold may be applied to the output color component instead of the raw color component. For example the threshold may be applied to the green output color created using the green ratio of raw color components, when the green output color is larger than the threshold the raw green color is used instead of the green output color. In another embodiment there may be a different threshold for each output color.

A color described using red, green, and blue components mixes saturation, hue, and brightness together. Some color models have independent axis for brightness, for example CIE defines a color space where L* is the brightness axis. In these types of color spaces a single threshold used in the brightness axis may be used to determine when a pixel is in a dark area of the image.

Once a pixel has been classified as being in a dark area of the image, the pixel can be treated in a number of ways. In one embodiment the pixels in the dark areas are left unchanged from the raw color photo-sensor output. In another embodiment the pixels in the dark areas of the image are transformed to a color using a second matrix. In another embodiment the pixels in the dark area of the image are converted to a shade of grey. Converting a color image to a shade of grey can be done using a second matrix, where each output color is created by the same ratio of input color components. One matrix that can be used to convert color images into shades of grey is the NTSC matrix.

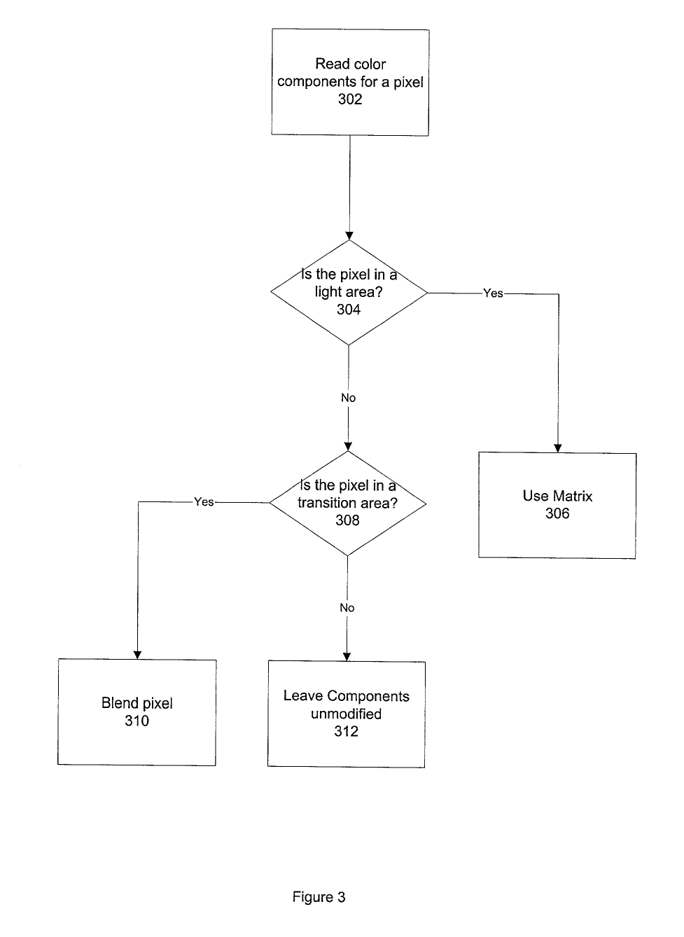

A sharp transition between output pixels that are created using the matrix and output pixels that are in the dark areas may create image artifacts. It may be desirable to blend or smooth the transition between the dark area pixels and the pixels created using the main matrix (see FIG. 3). When a pixel is in a light area of the image (304) the normal matrix is used (306). If the pixel is in a transition area (308) the pixel may be blended or smoothed (310). When the pixel is in a dark area of the image the raw color component may be used (312). There are many ways to define which pixels are in a transition area.

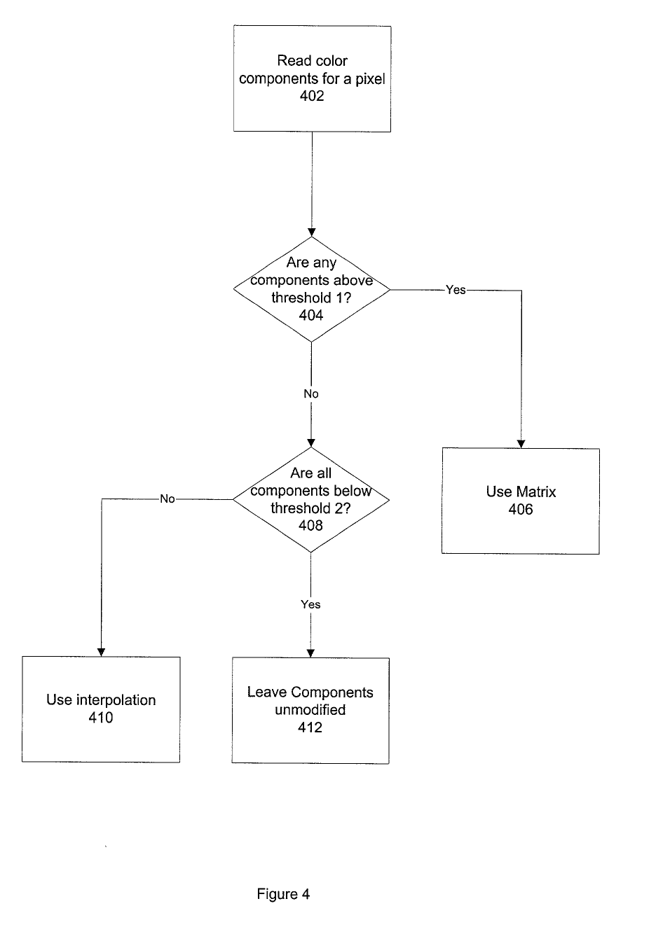

In one embodiment two thresholds are defined (see FIG. 4). In a preferred embodiment the upper threshold is 12 and the lower threshold is 8. Any pixel that has a color component above the higher threshold is not considered to be in the dark area. These pixels are transformed using the matrix (406). Pixels that have all their color components lower than the second threshold are left unmodified (412). Pixels that have all their color components below the higher threshold and have at least one color component between the two thresholds are considered to be in the transition area (410). In another embodiment pixels that have at least two color components between the two thresholds would be defined as being in the transition area. In another embodiment the raw color component that corresponds to the output color component would be required to be between the two thresholds before the pixel would be considered to be in the transition area. For example if the output color component was red, then the raw red color component would have to be between the two thresholds for the pixel to be considered to be in the transition area. More than two thresholds can be used to create more than one transition area. All the pixels falling into each transition area could be treated in a different way.

Once a pixel is defined as being in a transition area the pixel can be modified to help blend or smooth the transition between pixels in the dark areas and pixels not in the dark areas of the image. There are many ways to blend or smooth the transition area pixels. In one embodiment the pixels in the transition area are modified with a second matrix. In another embodiment the pixels in the transition area are modified by interpolation between the raw values and the transformed values from the matrix. For example if the high threshold is 12 out of 256 levels and the low threshold is 8, and a pixel has a raw red value of 11, a raw blue value of 6, and a raw green value of 4, and the red matrix values are 0.8 red, 0.1 green, and 0.05 blue, the matrixed red color component would be 0.8(11)+0.1(4)+0.05(6)=9.5. The interpolated red value between the raw red value of 11 and the matrixed red value of 9.5 would be: (12−8)/(11−8)=(9.5−11)/(X−11). Solving for X gives 9.875.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to clearly explain the principles of the invention and its practical application to thereby enable others skilled in the art to utilize the invention in various embodiments and various modifications as are suited to the particular use contemplated. It is intended that the appended claims be construed to include other alternative embodiments of the invention except insofar as limited by the prior art.

What is claimed is:

1. A method of processing color image data, comprising:
(a) examining the color components of a pixel in the image;
(b) selectively applying a matrix to the color components of the pixel to create an output color component only when the pixel is not in a dark area of the image.

2. The method of claim 1, further comprising:
repeating steps (a) and (b) for essentially each pixel in the image.

3. The method of claim 1, further comprising:
blending the transition between pixels in the image that are in a dark area and pixels in the image that are not in a dark area.

4. A method of processing color image data contained in an array of pixels, comprising:
selecting at least one threshold;
(a) reading the color components of a pixel;
(b) transforming the color components of the pixel with a matrix when any of the color components of the pixel are greater than the threshold and otherwise preserving the pixel.

5. The method of claim 4, further comprising:
repeating steps (a) and (b) for essentially each pixel in the array.

6. A method of processing color image data contained in an array of pixels, comprising:
(a) defining at least one threshold;
(b) defining a first and a second matrix;
(c) reading at least 3 color components for the pixel;
(d) applying the first matrix to the color components of the pixel to create an output color component when any of the color components are greater than the threshold, and;
(e) otherwise applying the second matrix to the color components of the pixel to create the output color component.

7. The method of claim 6 further comprising:
(f) repeating steps (c) through (e) for each pixel in the image.

8. The method of claim 7 where steps (a) through (f) are repeated to create a new output color component for each of the color components in the color image.

9. The method of claim 8 where a different threshold is used to create each output color component in the color image.

10. The method of claim 8 where there are different matrices for creating each output color component in the color image.

11. The method of claim 6 where the threshold is approximately 10 eight bit counts.

12. The method of claim 6 where the threshold is approximately 6 eight bit counts.

13. A scanner, comprising:
a photo-sensor array for converting an image into an electrical signal;
an A-to-D converter to convert the electrical signal into raw digital data;
a matrix for transforming the raw digital data into corrected digital data;
the scanner configured to output the corrected digital data only when the raw digital data is greater than a pre-selected value.

14. A method of processing color image data contained in an array of pixels, comprising:
defining a first threshold and a second threshold, where the first threshold is larger than the second threshold;
defining a first and a second matrix;
(a) reading the color components of a pixel;
(b) applying the first matrix to the color components of the pixel when any color component is greater than the first threshold;
(c) applying the second matrix to the color components of the pixel when all the color components of the pixel are less than the second threshold, and;
(d) otherwise applying an interpolation between the first and second matrix to the color components of the pixel;
repeating steps (a) through (d) for each pixel in the array.

15. A method of processing data contained in an array of pixels, comprising:
defining a threshold;
defining a range around the threshold, the range having a top end and a bottom end;
defining a matrix;
(a) reading the color components of a pixel;
(b) applying the matrix to the color components of the pixel when any of the color components are above the top of the high end;
(c) modifying the color components of the pixel by interpolation when all of the color components are below the top end of the high range and at least one color component is above the bottom end of the low range, and;
otherwise preserving the pixel.

16. The method of claim 15 further comprising:
repeating steps (a) through (c) for each pixel value in the array.

17. The method of claim 16 where steps (a) through (c) are repeated to create a new output color component for each of the color component in the color image.

18. The method of claim 17 where a different threshold is used to create each output color component in the color image.

19. The method of claim 17 where there are different matrices for creating each output color component in the color image.

20. The method of claim 15 where the threshold is approximately 10 eight bit counts.

21. The method of claim 15 where the range is approximately 2 eight bit counts.

22. The method of claim 15 where the threshold is approximately 6 eight bit counts.

23. A scanner, comprising:
a photo sensor array for converting an image into an electrical signal;
an A to D converter to convert the electrical signal into raw digital data;
a first matrix and a second matrix, both matrixes for transforming the raw digital data into corrected digital data;
the scanner configured to create the corrected digital data by selecting between the first and second matrix as a function of the raw digital data value.

24. A computer readable medium containing a program for adjusting the color data in an image, comprising:
a matrix;
the program configured to modify the data from a color component of the color image using the matrix only when the data from the color component is above a predetermined value.

25. A camera, comprising:
a photo sensor;
a lens system that forms an image on the photo sensor;
a matrix for mapping image data;
a processor configured to map image data only when the image data exceeds a predetermined value.

26. A camera, comprising:
a photo sensor;
a lens system that forms an image on the photo sensor;
a means for mapping the image data;
a processor configured to map the image data only when the image data exceeds a predetermined value.

27. A method of processing color image data contained in an array of pixels, comprising:
(a) defining at least three thresholds;
(b) defining a first and a second matrix;
(c) reading at least 3 color component for a pixel;
(d) applying the first matrix to the color components of the pixel to create an output color component when the first color component is larger than the first threshold or the second color component is larger than the second threshold or the third color component is larger than the third threshold, and;
(e) otherwise applying the second matrix to the color components of the pixel to create the output color component;
(f) repeating steps (c) through (e) for each pixel in the array.
